(19) United States
(12) Patent Application Publication
(10) Pub. No.: US 2006/0241232 A1
(43) Pub. Date: Oct. 26, 2006

(54) Coating and filler compositions comprising platy layered silicate pigments

(76) Inventors: Juan M. Garces, Midland, MI (US); Jamel F. Attal, Midland, MI (US)

Correspondence Address: THE DOW CHEMICAL COMPANY, INTELLECTUAL PROPERTY SECTION,, P. O. BOX 1967, MIDLAND, MI, 48641-1967, US

(21) Appl. No.: 10/555,118

(22) PCT Filed: Apr. 28, 2004
(86) PCT No.: PCT/US04/13044

§ 371 Date: Dec. 21, 2005

Related U.S. Application Data
(60) Provisional application No. 60/467,587, filed on May 2, 2003.

(51) Int. Cl. C08K 3/34

(52) U.S. Cl. 524/444; 106/415

(57) ABSTRACT

A coating composition comprising platy magadiite pigment(s); a paper product comprising platy magadiite pigments; and an aqueous suspension comprising platy magadiite and a suspending agent selected from the group consisting of; polyacrylate polymers, polyvinylalcohol polymers, maleic anhydride-containing copolymers, and polyphosphates, and a latex dispersion or emulsion of latex polymers selected from the group consisting of styrene butadiene polymers, acrylic polymers, carboxylated acrylonitrile: butadiene polymers, polyvinylchloride, polyvinyledenechloride, polystyrene, fluorinated polyethylene and polypropylene, and polytetrafluoroethylene; and an article or formulation comprising a platy layered silicate.

### BACKGROUND OF THE INVENTION

This invention relates to coating compositions and end-use applications thereof.

Paper is usually coated to enhance its aesthetic properties. Paper pigments are an integral part of modern paper coating and surface sizing technology. It is well known in the paper industry that a wide variety of pigments, such as titanium dioxide, calcium carbonate, talc, synthetic silicates, and clays such as bentonite and kaolin, are suitable for use as paper fillers and/or coatings. Kaolin, a naturally occurring hydrated aluminate silicate, is presently the most widely utilized and is available in a range of particle sizes and brightnesses.

Surprisingly little use is made by the paper industry of inorganic pigments based on silica or silicates, excluding kaolin clays. Silica and silicates and other pigments, such as TiO₂, comprise less than 3 percent of the paper pigments. High-structure amorphous silica pigments have been used in the paper industry to replace TiO₂, at least in part, or to improve ink receptivity. See, for example, G. Alderfer and R. Crawford, Chapter 12—“High Structure Amorphous Silica Pigments in Paper”, in Pigments for Paper/edited by R. W. Hagemeyer, TAPPI PRESS 1997.

It would be desirable to provide a new class of synthetic paper pigments based on silica or silicates and having a combination of features that are desirable to produce high quality paper products for the printing, food packing, and other industries.

### SUMMARY OF THE INVENTION

In a first aspect, the present invention is a coating composition comprising platy magadiite pigment(s).

In a second aspect, the present invention is a coating composition comprising a mixture of platy magadiite pigment(s) with another pigment selected from the group consisting of calcium carbonate, precipitated calcium carbonate (PCC), kaolin, talc, alumina trihydrate, and titanium dioxide.

In a third aspect, the present invention is a paper product comprising platy magadiite pigments.

In a fourth aspect, the present invention is an aqueous suspension comprising platy magadiite and a suspending agent selected from the group consisting of polyacrylate polymers, polyvinyl alcohol, polyphosphates and copolymers of styrene and maleic anhydride resins and other copolymers of maleic anhydride.

In a fifth aspect, the present invention is a suspension comprising platy magadiite, a suspending agent, and a latex polymer or binder selected from the group that includes, for example, styrene-butadiene latex, styrene-acrylate latex, styrene-butadiene-acrylonitrile latex, styrene maleic anhydride latex, styrene-acrylate-maleic anhydride latex, polysaccharides, proteins, polyvinyl pyrrolidone, polyvinyl alcohol, polyvinyl acetate, cellulose and cellulose derivatives.

The term “latex polymer” means herein a colloidal dispersion of a polymer in water comprising a cationic, anionic or nonionic polymer dispersed in the aqueous phase and an emulsifying agent.

In a sixth aspect, the present invention is a coating composition comprising layered silicates pigments selected from the group consisting of platy magadiite, platy kenyaite, platy octasilicate, platy KHSi₂O₅, platy Na₂Si₂O₅ platy talc, platy CaCO3, platy bentonite, platy mica, platy satin white, platy vermiculite and other platy pigments.

Other aspects of the present invention will become apparent from the following detailed description and claims.

As used herein, the term “platy magadiite” means a crystalline sodium silicate with a platy morphology comprising substantially flat plates with lateral dimensions [length and width] of from 0.2 to 10 microns, more preferably, from 0.5 to 5 microns and, most preferably, from 1 to 2 microns.

As used herein, the term layered silicate” means an inorganic material, such as a smectite clay mineral, that is in the form of a plurality of adjacent, bound layers and has a thickness, for each layer, of about 0.03 micron. to about 0.5 micron, preferably about 0.1 micron.

### DETAILED DESCRIPTION OF THE INVENTION

Preferably, the platy magadiite employed in the practice of the present invention is a synthetic magadiite comprising more than fifty percent by weight of platy magadiite, more preferably, more than eighty weight percent and, most preferably, more than ninety weight percent by weight of platy magadiite

Platy magadiite can be produced from water glass (water soluble sodium silicate), water and sodium hydroxide (NaOH) under hydrothermal or sub-hydrothermal conditions to yield a crystalline product having platy morphology with crystals resembling flat glass plates of from about 0.2 to about 10 microns in length and from about 0.1 to about 0.1 microns in thickness. The product is produced as a white powder and the platy morphology is ideally suited to produce white and very smooth coatings on paper.

The surface of platy magadiite can be made more or less hydrophilic or hydrophobic by adjustment of the sodium content via titration with inorganic or organic acids and/or by treatment with organic surfactants. These treatments can be used also to tune up the surface acid or basic character. Moreover, it is possible to introduce a variety of functional groups on the platy magadiite surface by reaction of surface silanol (Si—OH) with numerous chemicals to produce functional surface groups (Si—OR), which may facilitate the interaction of the platy magadiite pigment with the cellulose fiber matrix.

Platy magadiites can be modified with reactive organic coupling agents, such as, for example, organosilanes, alcohols and quaternary salts, to provide paper products with unique surface properties, such as, for example, optical and adhesive properties.

Platy magadiites and their method of preparation are described in detail in copending U.S. application Ser. No. 10/257,487, incorporated herein in its entirety by reference.

The platy magadiite pigments of the present invention can be used in a variety of applications such as, for example, nanofiller in polyolefin nanocomposites, paint pigment formulations, catalyst support [Ziegler and Metallocene] for polyolefin catalysts, dye stabilization for use in plastics or in textile fibers containing dispersed dye-magadiite pigment particles and the like.

The platy magadiite pigments can be used also in making (a) paper products comprising platy magadiite in combination with polymer films in bilayer or multilayer articles, b) latex products comprising magadiite in applications other than paper, such as paints and films for road signs, c) cardboard products, d) ink products, e) magadiite-latex additives to FR (flame retardant) formulations, f) magadiite modified with reactive organic coupling agents, such as organosilanes, alcohols, quaternary salts, etc. to provide paper products with unique surface properties, such as, for example, optical and adhesive properties.

The platy magadiite pigments can be used also in combination with binders, such as latex, starch and co-binders such as carboxy methyl cellulose (CMC) and other additives, including lubricants and surfactants, rheology modifiers and dispersing agents used to make paper coatings.

The platy magadiite pigments can be used also in the paper making process as a filler.

In general, the paper coating composition of the present invention can be prepared by dispersing the magadiite pigment in deionized water.

The amount of platy magadiite pigment used depends on the desired paper coating performance including sheet gloss, ink gloss, brightness, opacity, Helio, roughness, CIE whiteness, B-value, and the like; the relative amounts of other pigments such as calcium carbonate, kaolin, titanium dioxide; and the relative amounts of other components such as latex, surfactants and dispersing agents.

In general, the platy magadiite pigment is used in an amount of from about 0.1 wt. percent to about 30 wt. percent, more preferably, from about 1 wt. percent to about 30 wt. percent and, most preferably, from about 3 wt. percent to about 30 wt. percent, based on the weight of the paper composition comprising base paper or raw stock, paper pigment, and binder.

Advantageously, the platy magadiite pigments are suspended in water using suspending agents to disperse and stabilize the platy particles at concentrations and viscosities suitable for application as coatings on paper.

The suspending agents which can be employed in the practice of the present invention include, for example, polyacrylate polymers, such as, for example, DISPEX™ N40, a salt of a polymeric acid in aqueous solution, a product of Allied Colloids Inc., polyvinyl alcohol, such as, Polyvinyl Alcohol 103, a product of Air Products, polyphosphates, such as potassium tripolyphosphate, sodium hexametaphosphate, tetrasodium pyrophosphate, and copolymers of styrene and maleic anhydride resins and other copolymers of maleic anhydride.

The preferred suspending agents are polyvinyl alcohol, polyacrylate and maleic anhydride-containing copolymer resins, and polyphosphates. The more preferred suspending agents are polyvinyl alcohols, polyacrylate and polyacrylate copolymers. The most preferred suspending agents are Polyvinyl Alcohol 103 and Dispex™ N40.

The amount of suspending agent employed in the practice of the present invention depends on the desired solids content in the pigment dispersion and on the solids composition. In general, the suspending agent is used in an amount of from about 0.01 wt. percent to about 2.0 wt. percent, more preferably, from about 0.05 wt. percent to about 1.0 wt. percent and, most preferably, from about 0.05 wt. percent to about 0.5 wt. percent, based on the weight of the pigment in the composition.

Preferred latex polymer dispersions or binders which can be employed in the practice of the present invention include, for example, carboxylated styrene-butadiene latex, carboxylated styrene-acrylate latex, carboxylated styrene-butadiene-acrylonitrile latex, polyvinyl alcohol, and carboxylated copolymers of polyvinyl acetate and acrylate ester latex.

Polysaccharides which can be employed in the practice of the present invention include, for example, agar, sodium alginate and starch including modified starches such as thermally modified starch, carboxymethylated starch, hydroxyethylated starch and oxidized starch.

Examples of proteins that can be suitably used in the practice of the present invention include albumin, soy protein and casein.

The magadiite pigment of the present invention can be used in a variety of other applications such as, for example, nanofiller in polyolefin nanocomposites, paint pigment formulations, catalyst support [Ziegler and Metallocene] for polyolefin catalysts, dye stabilization for use in plastics or in textile fibers containing dispersed dye-magadiite pigment particles and the like.

The following working examples are given to illustrate the invention and should not be construed as limiting its scope. Unless otherwise indicated, all parts and percentages are by weight.

The terms used in the Examples are defined as follows:

| | |
|---|---|
| DISPEX ™-N40 | Salt of a polymeric acid in aqueous |
| | solution, a product of Allied |
| | Colloids Inc. |
| Cowl ™ Mixer | A high shear mixing system used to |
| | disperse the pigment and produce a |
| | stable slurry. This device is made |
| | by Morehouse Industries, Inc. |
| CP 638NA | Carboxylated styrene/butadiene |
| | latex, a product of The Dow Chemical |
| | Company. |
| FINNFIX ®10 | Carboxy methylcellulose, a rheology |
| | modifier. FINNFIX 10 is a |
| | registered trademark of |
| | Metsaeleeton. |
| RAP ™ 501NA | Carboxylated |
| | Styrene/butadiene/acrylonitrile |
| | latex, a product of The Dow Chemical |
| | Company. |
| Roto base | A paper that is coated with a |
| paper | pigment and binder package that is |
| | suitable to be printed using the |
| | Roto Gravure printing process. |
| Dow Bench | A table bench scale coater to |
| Blade coater | apply the paper coating formulation |
| | to the paper and uses a blade to |
| | doctor the excess coating to produce |
| | a smooth coated surface. |

### EXAMPLE 1

### Roto Gravure Coating Formulation

1) Pigment Dispersion

The pigment was dispersed in deionized water at 43 percent solids using 0.25 parts of a dispersant, Dispex-N40, based on 100 parts dry pigment. The dispersant was added to the water and then the platy magadiite pigment was slowly added while mixing with a Cowl Mixer. The agitation rate was increased when all the platy magadiite pigment is added to the water, and the platy magadiite pigment was left to mix for 15 minutes.

2) Paper Coating Formulation

Several paper coating formulations were prepared by mixing the different components for each coating formulation in the order that they appear in Table 1. The rheology modifier, carboxy methylcellulose (Finnfix 10) was added to provide some thickening to achieve the required coat weights. The formulations were prepared at 51 percent solids and the pH was adjusted with NaOH to 8.5.

3) Preparation of Samples

The paper coating formulation was applied using the Dow Bench Blade coater. The coatings were applied on a wood containing Roto base paper. The target coat weight was 4.5-lbs/3300 sq. ft.

The coated paper samples were then supercalendered using a standard lab scale super calender. The control, which is formulation 1, was calendered to target gloss at 1500 pounds per lineal foot (phi) and 67° C. The same super calender conditions were then used for all other coating systems.

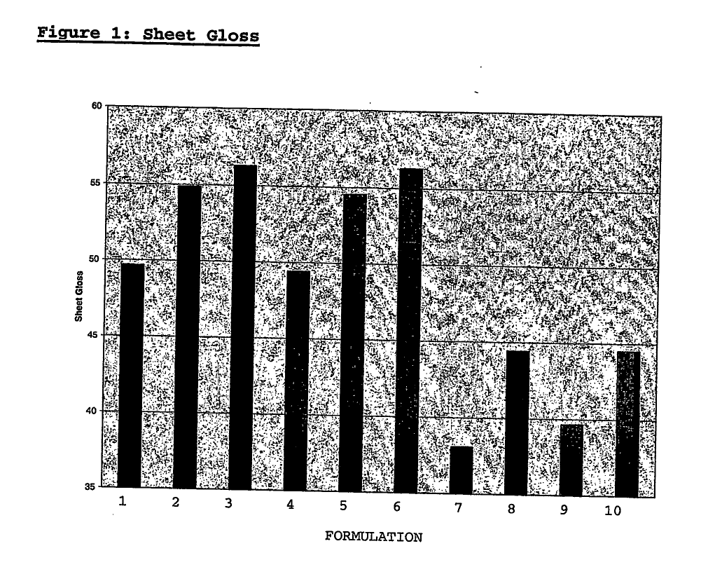

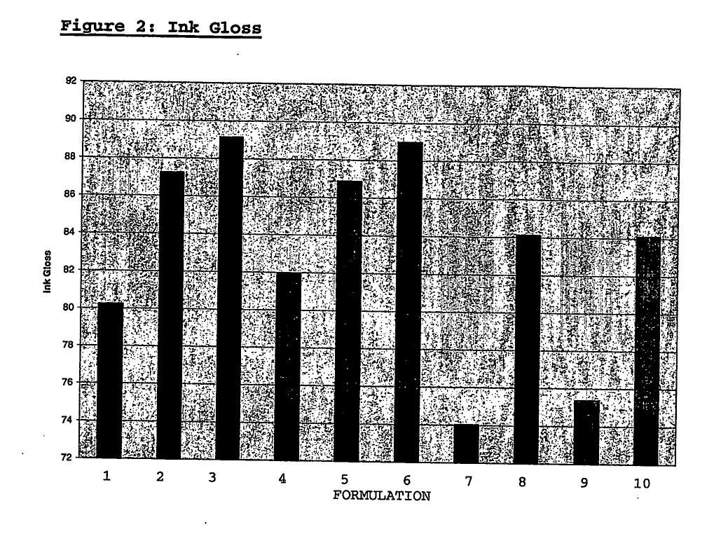

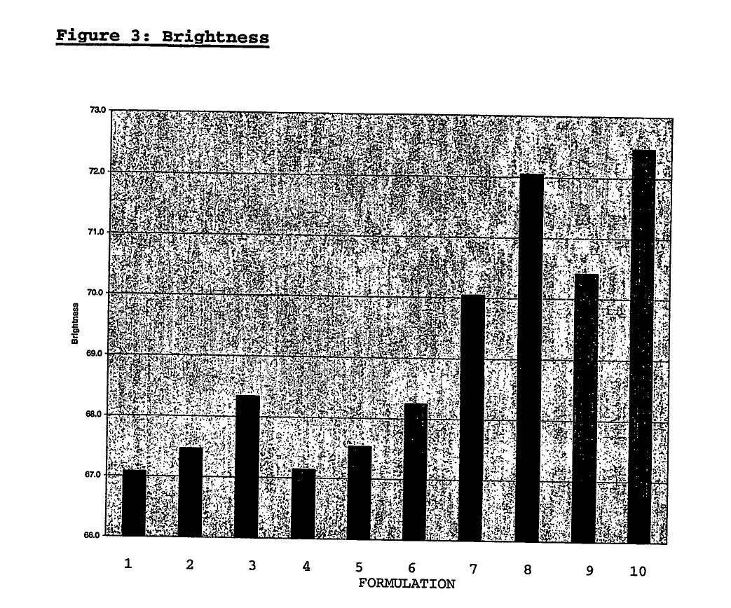

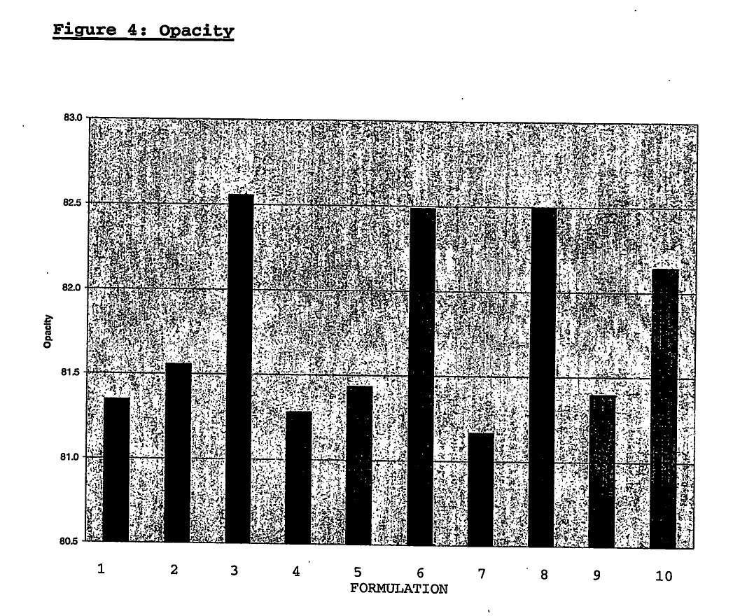

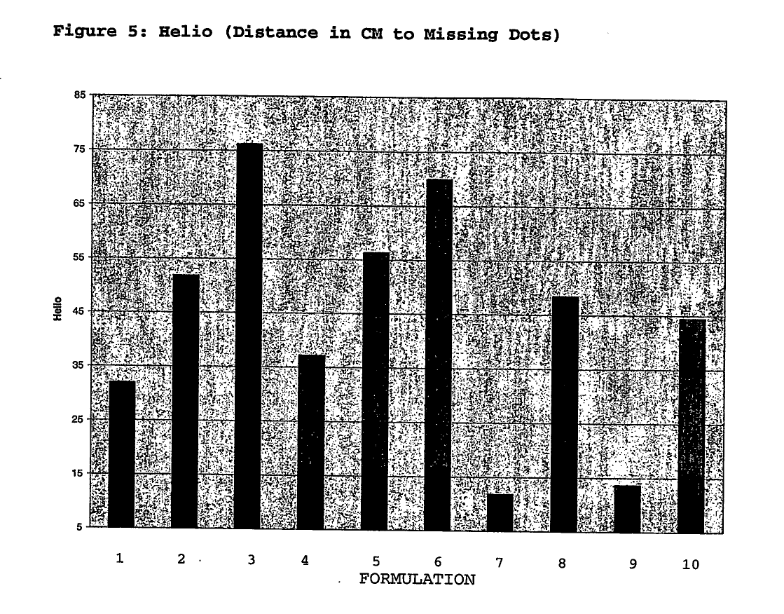

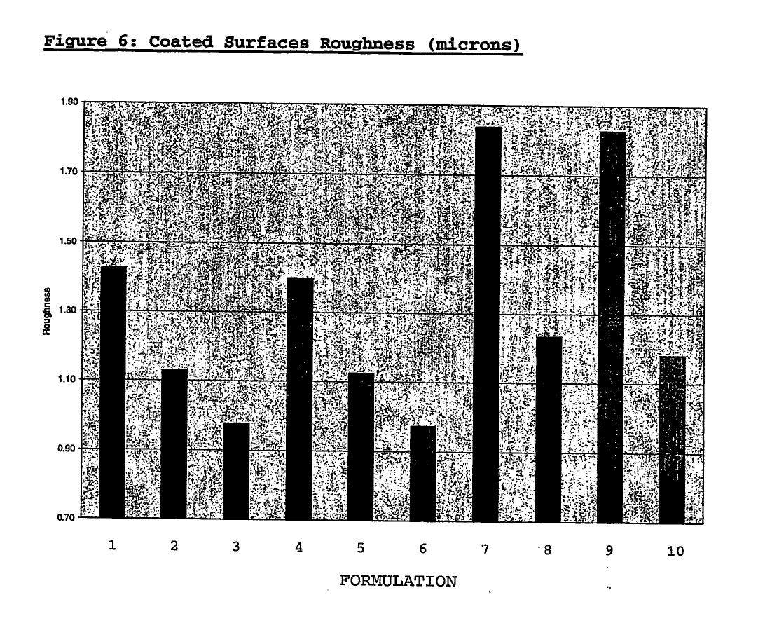

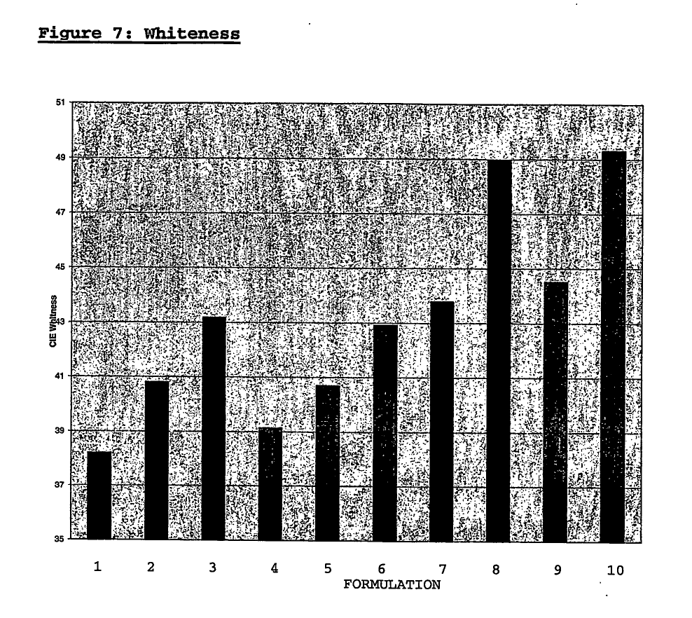

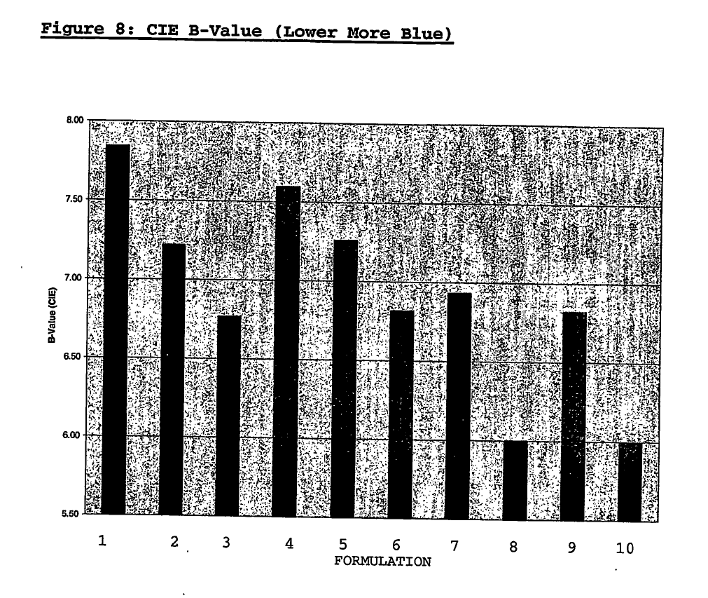

The paper samples were then left to condition to constant moisture condition before testing. The samples were then tested for key properties including optical and print performance. The results are shown in FIGS. 1-8.

| Test Procedures | |
|---|---|
| 1. Sheet Gloss | TAPPI Test Method - T480 |
| 2. Ink Gloss^{A} | |
| 3. Brightness | TAPPI Test Method - T646 |
| 4. Opacity | TAPPI Test Method - T425 |
| 5. Helio^{B} | |
| 6. Roughness | TAPPI Test Method - T555 |
| 7. Whitenesss | TAPPI Test Method - T-560 |
| 8. CIE B-Value | TAPPI Test Method - T-560 |
| 9. Coated Paper Strength | TAPPI Test Method - T514 |
| ^{A}Ink Gloss Test Procedure | |
| A thin ink film is applied to a strip of paper using a Prufbau Printability tester and then the ink is allowed to dry at room temperature. The printed samples are then measured for ink gloss (Print Gloss) using the same procedure as in T480. The only difference is the application of the ink film using the Prufbau. The Prufbau Printability Tester is a product of Prufbau Company in Germany. | |
| ^{B}An Helio Test Procedure | |
| An ink film is applied using a Reprotest I.G.T. ACII 5 Printability Tester product of IGT, and Heliotest Kit. The ink is applied to the paper using an engraved wheel following the procedure described below. When the ink is transferred from the engraving of the wheel to the paper, sometimes ink does not transfer from some of the cells or engravings. | |
| # This will result in a missed ink dot on the printed paper. This phenomenon is referred to as a missing dot. The number of missing dots in a 20 mm length of a printed strip of paper is used as a measure to quantify the quality of the Roto print. The higher the number of the missing dots, the lower the print quality. An optimal number is 0 missing dots. | |

Procedure:
1. Replace cardboard backing on IGT with green rubber backing and Mylar Film from Heliotest kit.
2. Place support-holder plate into upper IGT slot. Attach beveled blade to weight arm and slide onto plate. Adjust plate so that the blade rests aligned on the Heliotest wheel and tighten (plate should be approximately vertical).
3. Switch IGT to constant speed and set speed to 1.0 m/s remember to use constant speed scale.
4. Start with pressure (upper hub) of 50 kilogram force (kgf).
5. Place 2 to 3 drops Heliotest ink onto engraved wheel with measuring scale and spin wheel clock-wise. Only engraved depressions should appear tinted against the shine of the chrome. (Heliotest ink is prepared by cutting gravure printing ink with N-butyl carbitol acetate to 75 cP brookfield or 23 seconds with #4 Shell cup.) If streaking occurs, clean wheel and IGT's beveled blade. Re-ink as needed to keep even distribution in the depressions of the wheel.
6. Stop wheel with the blade resting within 1 inch of the end of the wide band.
7. Run a strip (strips need only be attached by the lead clip).
8. Count missing dots in the inked band on strip from dark to light. Mark strip at 20 missing dots. This should fall approximately 60 to 70 for the control then the rest of the samples are run at that condition. If it is out of this range, adjust pressure until it is reasonably close. (Raising pressure should raise the 20-dot mark).
9. Run samples randomly. Measure distance in mm to the mark. The greater distance to 20 missing dots, the better the printability.
10. Clean up with acetone.

TABLE 1
Paper Coating Formulation
Total of 100 Parts Including Plastic Pigment

| | Formulations 1-10 | | | | | | | | | |
|---|---|---|---|---|---|---|---|---|---|---|
| PIGMENTS | 1* | 2 | 3 | 4* | 5 | 6 | *7 | 8 | 9* | 10 |
| Hydraprint | 100 | 85 | 75 | 100 | 85 | 75 | | | | |
| Hydrocarb 90 | | | | | | | 100 | 75 | 100 | 75 |
| Magadiite | | 15 | 25 | | 15 | 25 | | 25 | | 25 |
| BINDERS/ADDITIVES | Dry Parts per 100 parts Pigment | | | | | | | | | |
| Rap 501 | 6 | 6 | 6 | | | | 6 | 6 | | |
| CP 638 | | | | 6 | 6 | 6 | | | 6 | 6 |
| Finnfix 10 | 0.5 | 0.5 | 0.5 | 0.5 | 0.5 | 0.5 | 0.5 | 0.5 | 0.5 | 0.5 |
| Aim Points: | | | | | | | | | | |
| % Solids | 51% | 51% | 51% | 51% | 51% | 51% | 51% | 51% | 51% | 51% |

*control

FIGS. 1-9 show that the use of Magadiite pigment in any formulation and with any latex resulted in:

1) Better gloss and printed ink gloss.

2) Better brightness with pigment systems; clay and carbonate. However more brightness improvement with the carbonate formulation.

3) Better opacity with both pigment systems and with both latexes.

4) Better Whiteness and more blue coating with both with all the different systems.

5) Far better Hellio, which is a measure of Gravure, print quality. This improvement was evident across all the systems.

6) Offset latex like CP 638NA demonstrated improved Roto prints performance in the presence of platy magadiite-based pigment. This could not be done with traditional pigment systems.

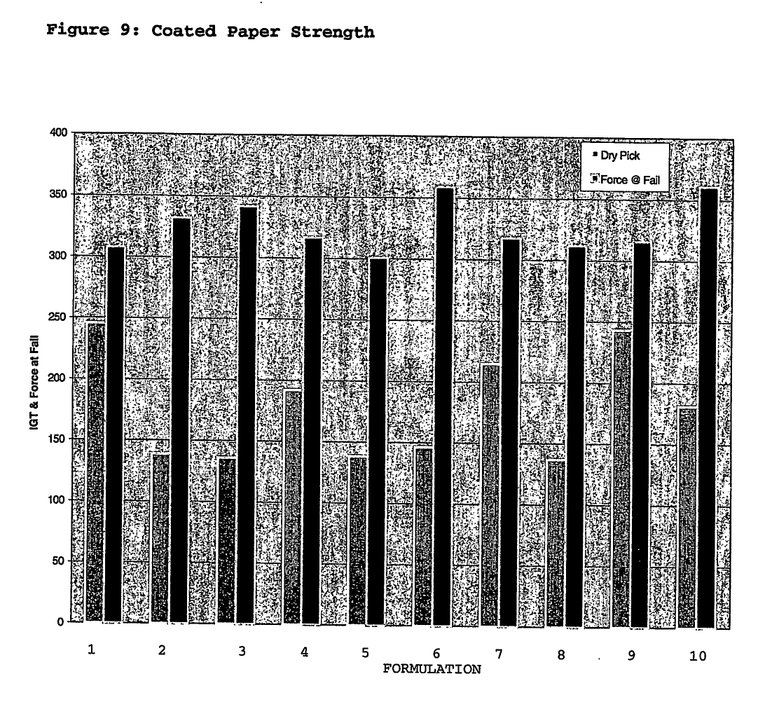

7) The coated paper surface with platy magadiite appears to have a higher binder demand as shown by FIG. 9. This suggest that coating made with platy magadiite will require slightly more binder especially for the offset printing process.

Although the invention is specifically described with respect to the preferred embodiment, that is, platy magadiite, the present invention also encompasses other platy layered silicates, such as platy octasilicate, platy kenyaite and related materials such as platy KHSi₂O₅, and platy Na₂Si₂O₅. These platy layered silicates typically have a platy morphology comprising substantially flat plates which are from 0.5 to 10 microns long, and from 0.01 to 0.1 microns thick, or have aspect ratios of from 5 to 1000.

1. A coating composition comprising platy layered silicate pigment(s).

2. The coating composition of claim 1 wherein the layered silicate pigment(s) is present in an amount of from 0.1 wt. percent to 30 wt. percent, based on the weight of the composition.

3. The coating composition of claim 1 wherein the platy layered silicate is a synthetic magadiite comprising more than fifty percent by weight of platy magadiite.

4. The coating composition of claim 1 wherein the platy magadiite is a synthetic magadiite comprising more than eighty percent by weight of platy magadiite.

5. The coating composition of claim 1 wherein the platy magadiite is a synthetic magadiite comprising more than ninety percent by weight of platy magadiite.

6. The coating composition of claim 1 wherein the platy layered silicate is selected from the group consisting of platy magadiite, platy kenyaite, platy octasilicate, platy KHSi₂O₅, and platy Na₂Si₂O₅.

7. The coating composition of claim 1 further comprising another pigment selected from the group consisting of calcium carbonate, precipitated calcium carbonate (PCC), kaolin, talc, alumina trihydrate, titanium dioxide, platy talc, platy CaCO3, platy bentonite, platy mica, platy satin white and platy vermiculite.

8. The coating composition of claim 3 wherein the platy magadiite is modified with a reactive coupling agent selected from the group consisting of organosilanes, alcohols and quaternary salts.

9. A paper product comprising a coating prepared using the composition of claim 1.

10. (canceled)

11. (canceled)

12. (canceled)

13. A latex product comprising platy layered silicate pigments.

14. The latex product of claim 13 wherein the platy layered silicate is a synthetic magadiite comprising more than fifty percent by weight of platy magadiite.

15. (canceled)

16. (canceled)

17. (canceled)

18. (canceled)

19. An aqueous suspension comprising a platy layered silicate, a suspending agent and a latex polymer.

20. The aqueous suspension of claim 19 wherein the suspending agent is selected from the group consisting of polyphosphates, polyacrylate polymers, polyvinylalcohol polymers, and maleic anhydride-containing copolymers.

21. The aqueous suspension of claim 19 wherein the platy layered silicate is a synthetic magadiite comprising more than fifty percent by weight of platy magadiite.

22. The aqueous suspension of claim 19 wherein the platy layered silicate is a synthetic magadiite comprising more than eighty percent by weight of platy magadiite.
